(19) United States
(12) Patent Application Publication
(10) Pub. No.: US 2004/0108616 A1
(43) Pub. Date: Jun. 10, 2004

(54) Method for producing a foamable plastic

(76) Inventor: Andreas Beckmann, Bielefeld (DE)

Correspondence Address: JORDAN AND HAMBURG LLP, 122 EAST 42ND STREET, SUITE 4000, NEW YORK, NY, 10168, US

(21) Appl. No.: 10/423,409

(22) Filed: Apr. 25, 2003

(30) Foreign Application Priority Data
Apr. 26, 2002 (DE) 102 18 696.0-16

(51) Int. Cl. B29C 44/02

(52) U.S. Cl. 264/51

(57) ABSTRACT

For producing a foamable plastic, a physical blowing agent is supplied in the solid state to the plastic. Advantageously, the blowing agent is surrounded by a solid casing, which is dissolved when the plasticizing equipment is reached, the blowing agent being supplied to the plastic in the flowable and/or pourable state, especially in the form of tablets or powders. The blowing agent may also be supplied in the form of an endless material.

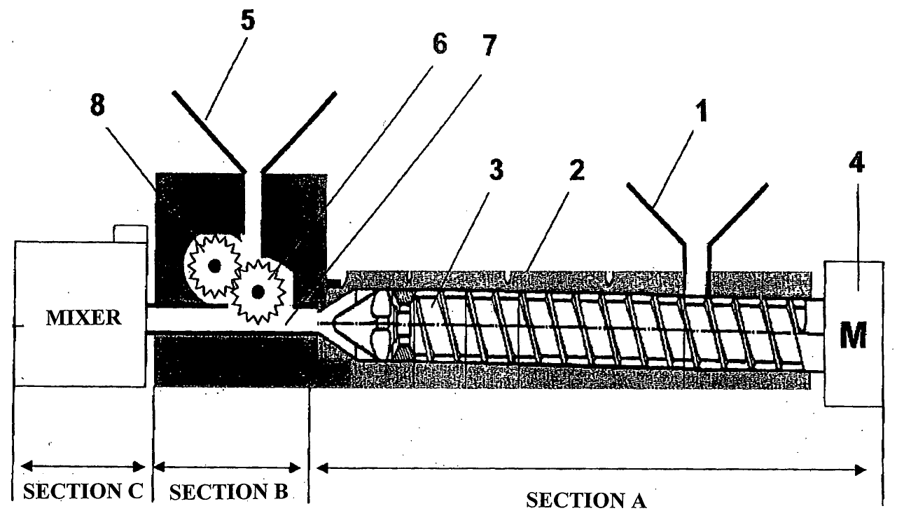

The invention relates to a method for producing a foamable plastic, for which at least one blowing agent is supplied to the plastic, in order to obtain a foamable plastic.

For conventional methods, physical blowing agents, such as carbon dioxide or nitrogen or their mixture are supplied to the molten and homogenized plastic melt in the gaseous, liquid or supercritical state. This may take place, for example, in an extruder, a blow-molding machine or in an injection-molding machine. For manufacturing methods with a discontinuous melt preparation process (injection molding, extrusion blow molding employing the storage head principle), the blowing agents are also metered in discontinuously by metering devices.

When physical blowing agents are used, the state of aggregation of these blowing agents is changed in order to increase the solubility of the blowing agents in the polymer and/or to improve the foam quality.

It is a disadvantage of previous methods that so-called high-pressure installations must be used, in which gasses are added to the plastic in some cases at pressures of 500 bar.

It is therefore an object of the invention to do without the use of high-pressure installations in processes for producing a foamable plastic.

Pursuant to the invention, this objective is accomplished owing to the fact that the blowing agent is supplied in the solid state.

Advantageous developments are indicated in the dependent claims.

A device for carrying out the inventive method is shown in the single FIGURE.

In a device for carrying out the inventive method, which is shown in the FIGURE, plastic granulate is added over a first funnel 1 to plasticizing equipment 2 in a first section A, melted and homogenized.

Due to the conveying action of a screw 3, which is driven in plasticizing equipment 2 by the motor 4, the molten and homogenized plastic material reaches a second section B, where the blowing agent, such as carbon dioxide, is supplied to the plastic melt pursuant to the invention in the solid state of aggregation.

This blowing agent is supplied, for example, in powder or granular form and is made available over a second funnel 5. The blowing agent in the solid state of aggregation is metered in an over a first gearwheel 6, which transports the blowing agent from the second funnel 5 into a melt channel 7, which is connected permanently in with the plasticizing equipment 2.

The first gearwheel 6 is such that the number of teeth and/or the depth of the gearwheel flanks and/or the rotational speed of the first gearwheel 6 are coordinated with the amount of blowing agent required.

The first gearwheel 6 is driven by a motor, which is not shown in the FIGURE. Since the danger exists, when metering with the help of the first gearwheel 6, that molten plastic will be entrained from the melt channel 7, a second gearwheel 8 is used for combing out the first gearwheel 6.

The melt, which now contains blowing agent, subsequently reaches a third section C, where intensive mixing of the melt with the blowing agent takes place. When sufficient mixing is achieved, the plastic is sprayed through a nozzle from the mixing arrangement into a mold into normal atmospheric conditions or into a mold, the plastic cooling and being subjected to do a large pressure drop, as a result of which it foams.

Pursuant to the invention, the blowing agents, such as nitrogen or carbon dioxide, can be supplied to the plastic melt, for example, in the solid state of aggregation, for example, in powder or tablet form. For this purpose, a metering device measures out the amount required and supplies it to the second funnel 5.

Moreover, the blowing agent may be present as a bar in the solid state of aggregation. The bar extends from the metering device into the second funnel 5 and an appropriate length of it is supplied as required.

In a further embodiment of the inventive method, the blowing agent is surrounded by a solid casing, which contains a certain amount of the blowing agent. The latter can be disposed, for example, in a spherical casing, which is supplied to the metering device. The latter passes on this sphere to the second funnel 5, as required.

The casing preferably is formed from a plastic, which is compatible with the plastic melt. In this way, it is ensured that, when the casing dissolves in the plastic melt, by-products or incompatibilities, which can have a negative effect on the plastic that is to be processed further, are not formed. Due to the use of such casings, it is also possible to supply a chemical blowing agent or a mixture of a chemical and a physical blowing agent in the solid state to the plastic melt. A casing preferably is used in the case of blowing agents, such as water, which are not flowable in the solid state of aggregation.

The distinguishing features and advantages of the invention, disclosed in the preceding specification, the FIGURE as well as in the claims, may be essential individually, in their various embodiments, as well as in any combination for the realization of the invention.

### Legend for Drawing

Abschn.=Abschnitt=Section

Mischer=mixer

1. A method for producing a foamable plastic, for which at least one blowing agent is supplied to a plastic, in order to obtain a foamable plastic, characterized in that the blowing agent is supplied in the solid state.

2. The method of claim 1, characterized in that a physical blowing agent is used as blowing agent.

3. The method of one of the preceding claims, characterized by the use of a mixture of chemical and physical blowing agents.

4. The method of one of the preceding claims, characterized in that the blowing agent or agents is supplied to the plastic in the solid state of aggregation.

5. The method of one of the claims 1 to 5, characterized in that the blowing agent or agents is/are encased in a solid casing when supplied to the plastic.

6. The method of claim 5, characterized in that the casing is dissolved when it has reached the plasticizing equipment (2).

7. The method of one of the preceding claims, characterized in that the blowing agent or agents is/are supplied to the plastic in the flowable and/or pourable state, especially in the form of tablets or a powder.

8. The method of one of the preceding claims 1 to 7, characterized in that the blowing agent is supplied to the plastic in the form of endless material.

9. The method of one of the preceding claims, characterized in that the plastic is kept in the molten state while the blowing agent is being supplied.

10. The method of one of the claims 1 to 9, characterized in that the plastic or preliminary stages of the plastic is or are kept in the solid state, especially as a granulate, while the blowing agent is being supplied.
